(19) United States
(12) Patent Application Publication
(10) Pub. No.: US 2010/0309508 A1
(43) Pub. Date: Dec. 9, 2010

(54) NETWORK PRINT-RELATED SERVICE

(76) Inventors: Harish B. Kamath, Bengalooru (IN); Sridhar Solur, London (GB); Sangamesh S. Bellad, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/543,609

(22) Filed: Aug. 19, 2009

(30) Foreign Application Priority Data
Jun. 3, 2009 (IN) 1280/CHE/2009

(51) Int. Cl. G06F 15/00

(52) U.S. Cl. 358/1.15

(57) ABSTRACT

To perform a network print-related service, a client computer requests information relating to locations of print-related services accessible over a public network. The client computer receives identifications of locations at which available print-related services are accessible over the public network. According to the identifications of locations, one of the locations is selected for submitting a request for a print-related service over the public network.

### BACKGROUND

Within an enterprise (such as a company, educational organization, or government entity), printers may be attached to networks. Users within the enterprise can submit print jobs from user computers to the printers over the networks.

Before a user computer can submit a print job to a network printer, a printer driver typically has to be first loaded in the user computer. Moreover, a user has to know ahead of time where the printers are located such that the user can select the appropriate printer to submit a print job.

### BRIEF DESCRIPTION OF THE DRAWINGS

Some embodiments of the invention are described with respect to the following figures:

FIG. 1 is a block diagram of an exemplary arrangement that provides network printing according to an embodiment of the invention;

FIG. 2 is a flow diagram of a process performed by client print software according to an embodiment;

FIG. 3 is a flow diagram of a process performed by server print software according to an embodiment;

FIG. 4 is a schematic diagram showing an application programming interface (API) between the client print software and server print software, according to an embodiment; and

FIG. 5 is a flow diagram of uploading a print job, according to an embodiment.

### DETAILED DESCRIPTION

Conventionally, before a user can use a user computer to print to a printer, a device driver for the printer (as well as associated application software) has to be first loaded on the user computer. In a network environment in which multiple printers are accessible over a network, the user computer can be loaded with multiple device drivers corresponding to the multiple printers. Moreover, a user is typically burdened with having to determine ahead of time where the printers are located—otherwise, a user will have no idea where to pick up a printout. In addition, when a user is away from the network environment (which can be part of an enterprise, for example), the user will not have access to printers in the network environment. For example, when a user is traveling, the user may have a hard time finding a printer where the user may perform desired printing.

In accordance with some embodiments, a framework is provided to allow users to conveniently determine locations at which printers or print-related services are available over a network, such as a public network (e.g, the Internet). A “print-related service” refers to any service that is associated with printing, such as document printing, document binding, document copying, and so forth. Note that “print-related service” also refers to provision of printer(s). A “public network” refers to any network in which users are able to communicate with other users or to access resources on the network. The public network can be an open network accessible to anyone, or alternatively, the public network can be a subscription-based network available to subscribers.

The framework provides one or more portals (e.g., web portals) accessible by client computers (e.g., notebook computers, desktop computers, personal digital assistants or PDAs, smart phones, etc.) associated with users. The portals allow the client computers to obtain identifications of locations at which print-related services are accessible over the public network. The locations at which print-related services are accessible may be locations associated with print service providers. A “print service provider” is any entity that publishes (or makes available) one or more print-related services associated with the entity over a network. A print service provider can be a corporation, a user, a group of users, or any other entity that provides other print-related services for access by end users.

In the ensuing discussion, reference is made to accessing printers provided by the framework according to some embodiments. It is noted, however, that the framework according to some embodiments can be used to access other print-related services.

A print service provider can provide a public print network (that is generally accessible to users), a private print network (that is subject to access restrictions and available to a restricted group of users), or a social print network (that is accessible by users who are part of a social group). As examples, the public print network includes one or more printers available to users on the web. The private print network includes one or more printers attached to a network within an enterprise or other protected environment. A social print network includes one or more printers available to users who are socially connected (e.g., users who are on a buddy list for text chat, users who are friends on social websites, and so forth).

In accordance with some embodiments, in response to requests for available printers from a client computer, the client computer can be provided with information to enable the client computer to display a map that identifies locations (such as by use of icons or other visual indicators) at which printers are available over a network. The displayed map can be a map generated by a map service provider such as GOOGLE™, YAHOO®, or other service provider. More generally, a “map” refers to any visual representation of geographic locations. Annotations regarding printers can then be added to the visual representation of geographic locations.

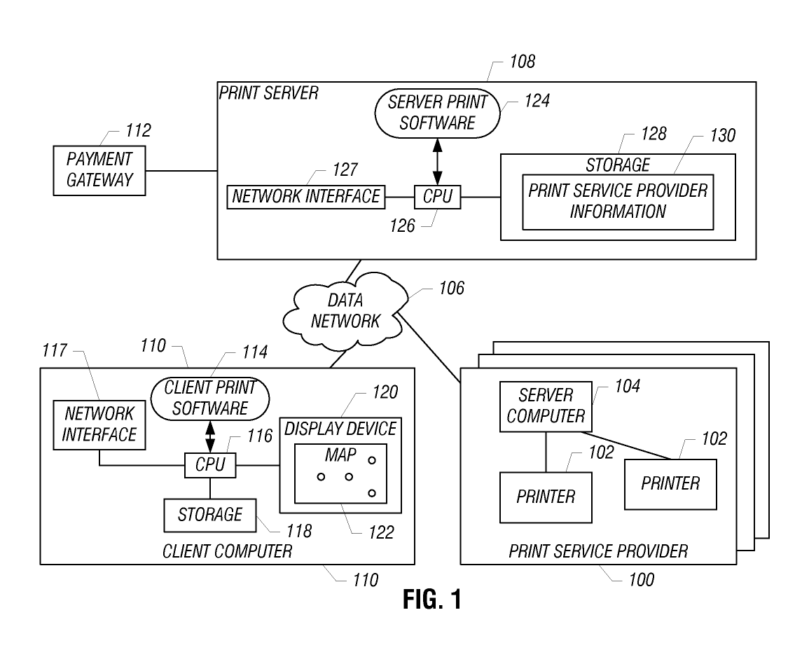

FIG. 1 depicts an exemplary arrangement that includes various print service providers 100. Each print service provider 100 includes one or more printers 102 (as well as other print-related services). As depicted, the one or more printers 102 of a print service provider 100 can be attached to a server computer 104 associated with the print service provider 100. In alternative embodiments, the server computer 104 can be omitted. Printers 102 that are associated with each print service provider 100 can be part of a print network (e.g., public print network, private print network, or social print network, as discussed above).

A print network is accessible over a data network 106 (e.g., the Internet or other type of data network). The data network 106 can include a wired network and/or a wireless network. A print server 108 is also connected to the data network 106. The print server 108 is the portal through which a client computer 110 is able to access the printers 102 of the print service providers 100. The client computer 110 can communicate with the print server 108 to identify locations at which printers are available over the data network 106. Based on the identified locations, a user at the client computer 110 can select a printer from a convenient location (e.g., location closest to the user, location having a lowest fee, etc.) for submitting a print job.

The print server 108 can be connected to a payment gateway 112 to allow the print server 108 to collect payment for a print request submitted by the client computer 110.

Although just one client computer 110 and print server 108 are depicted in FIG. 1, it is noted that in alternative implementations there can be multiple client computers and/or print servers.

As further depicted in FIG. 1, the client computer 110 includes client print software 114 that can interact with the print server 108 to perform tasks according to some embodiments. The client print software 114 is executable on one or more central processing units (CPUs) 116 in the client computer 110. The CPU(s) 116 is (are) connected to storage media 118.

Moreover, the client computer 110 includes a display device 120. In accordance with some embodiments, the display device 120 is able to display a map 122 identifying locations (represented by circles in the map 122) at which printers are available. The map 122 can be displayed in response to a request from the client computer 110. The locations associated with printers can be annotated with information regarding such printers. For example, the annotated information can identify a print service provider and/or provide other information.

The print server 108 includes server print software 124 executable on one or more CPUs 126 connected to storage media 128. The storage media 128 includes print service provider information 130 associated with the service providers 100. The print service provider information 130 can be retrieved from the server computer 104 associated with each print service provider 100. The print service provider information 130 can be used to provide information relating to the print service providers 100 and printers 102 of the print service providers 100 to the client computer 100.

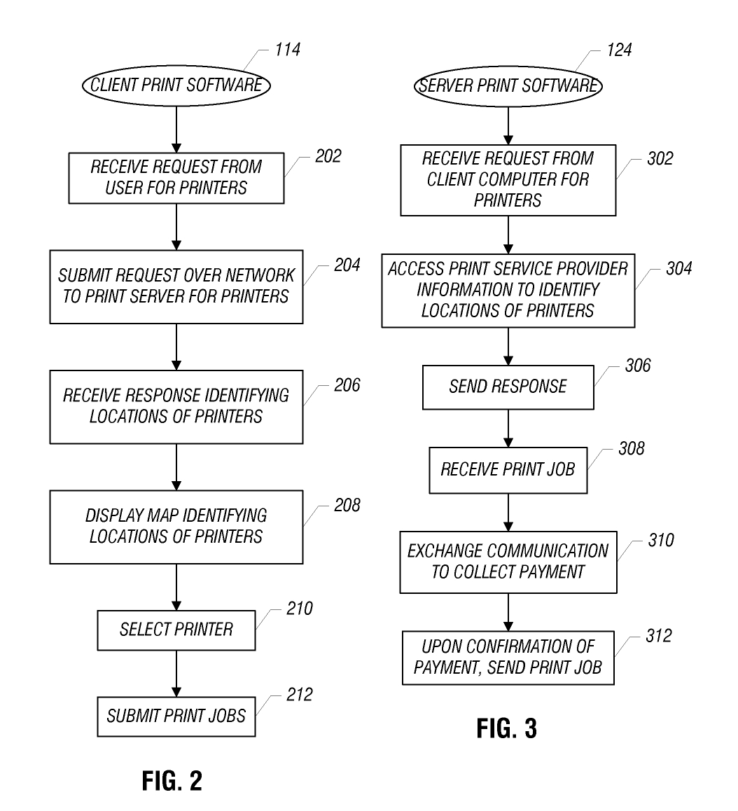

FIG. 2 is a flow diagram of a process performed by the client print software 114 in the client computer 110 according to an embodiment. The client print software 114 receives (at 202) a request from a user for available printers. The client print software 114 can present a graphical user interface (GUI), for example, that allows a user to submit a request for available printers. The GUI can be presented by a web browser, for example.

In response to the user request, the client print software 114 submits (at 204) a request over the network 106 (FIG. 1) to the print server 108 to identify available printers. The request submitted by the client print software 114 can specify a general geographic region of interest. For example, if the client computer 110 associated with the user is a portable device such as a notebook computer, PDA, or smart phone, then location information (e.g., global positioning system or GPS location information) associated with the portable device can provided with the request. The location information can be used by the print server 108 (FIG. 1) to narrow down the printers (or print service providers) that are to be identified. For example, the identified printers (or print service providers) are those within some distance of the location of the user. The request can also specify other criteria that are to be considered by the print server 108 to narrow down the printers (or print service providers) that are to be identified. For example, the criteria may specify that the user is interested in only color printers, high-speed printers, and so forth.

In response to the request submitted at 204, the client print software 114 receives (at 206) a response identifying locations at which printers are available. Based on information in the response, the client print software 114 displays (at 208) a map identifying locations at which printers are available.

The identified locations may be associated with print service providers. A user may cause a further request to be submitted to obtain more detailed information regarding the printers associated with a particular print service provider. The more detailed information can specify the types of printers available, and the fees charged for using such printers, among other information.

Based on the information provided to the user, the user can select (at 210) a printer (or print service provider) from among the printers (or print service providers) identified in the displayed map. The user can then cause a print job to be submitted to the selected printer (or print service provider).

Note that in an alternative embodiment, instead of selecting an available printer (or print service provider) to submit a print job, a print-related service provided by a print service provider can be selected by a user.

FIG. 3 is a flow diagram of a process that can be performed by the server print software 124 in the print server 108 of FIG. 1. The server print software 124 receives (at 302) a request from a client computer 110 for available printers. In response to the received request, the server print software 124 accesses (at 304) print service provider information 130 (FIG. 1) stored in the print server 108. From the print service provider information 130, the server print software 124 can identify printers (or print service providers) that match criteria specified in the request. The criteria can include location criteria, printer capability criteria (e.g., color printer, high-speed printer, etc.).

Based on the identified printers (or print service providers), the server print software 124 then sends (at 306) a response containing an identification of the locations at which printers are available. The response is sent to the client computer 110.

Once the user has selected a printer (or print service provider) and a print job has been submitted by the client computer 110, the server print software 124 receives (at 308) the submitted print job. Upon receiving the print job, the server print software 124 performs (at 310) a communication exchange to collect payment information such that the user can be charged for the submitted print job. The communication exchange can include receiving credit card information, in one example. In other implementations, other charging techniques can be employed. In other implementations, task 310 can be omitted. More generally, whether or not the communication exchange to collect payment information is performed is based on print service provider configuration.

The server print software 124 next submits (at 312) the print job to the selected printer (or print service provider).

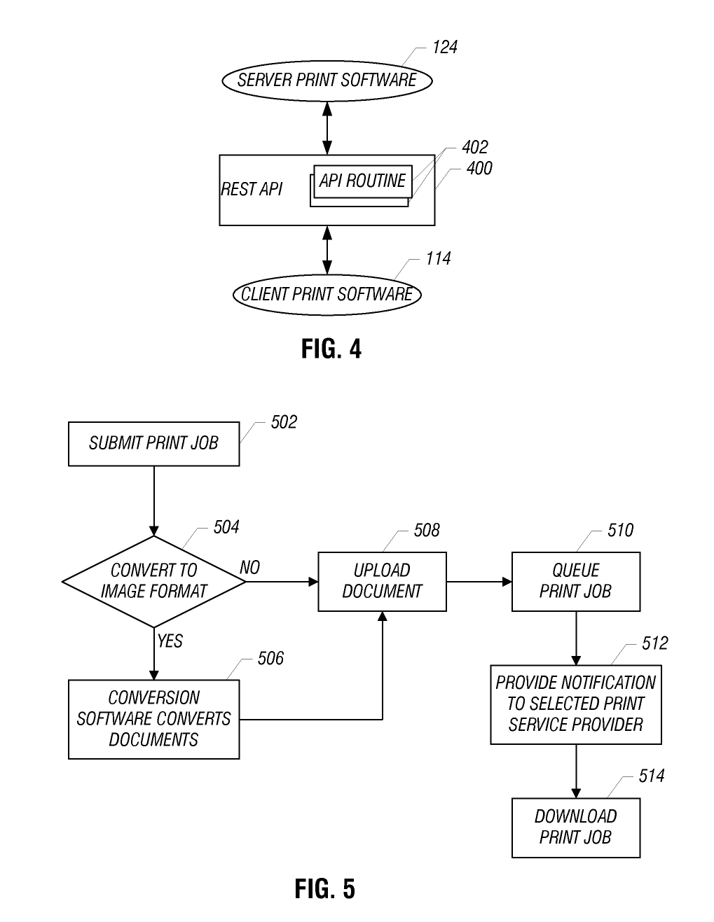

As shown in FIG. 4, an application programming interface (API) 400 is provided between the client print software 114 and server print software 124. In one embodiment, the API 400 is a REST (Representational State Transfer) API. The REST framework specifies resources that are referenced by global identifiers (such as uniform resource identifiers or URIs). To manipulate such resources, components of the network (which in this case include the client print software 114 and server print software 124) communicate using a standardized interface such as HTTP (Hypertext Transfer Protocol).

The API 400 includes various API routines (or methods) 402 that can be invoked by the client print software 114 or server print software 124. As examples, the API routines 402 include a routine to create a print job, which can be submitted using an HTTP POST method, for example. Another API routine 402 is used to obtain a listing of printers (or print service providers) that meet certain criteria.

By using the REST API 400 according to an embodiment, easier integration can be achieved since the API routines can be used to perform communications associated with performing print-related services, without having to address conflicts or inconsistencies that may arise due to use of different operating systems in different nodes (e.g., the client computer 110 and print server 108). Also, by using the REST API 400 according to some embodiments, print device drivers do not have to be provided in the client computers to enable access of printers or other print-related services.

Another issue associated with accessing remote print-related services is that differences in platforms, document format variances, unavailability of software, and/or other causes may prevent recognition of documents such that printing or other print-related services cannot be performed. Format conversion can be performed to address this issue. Format conversion can be performed at any of the nodes shown in FIG. 1, such as the print server 108, the server computer 104, or the client computer 110.

FIG. 5 illustrates a process of uploading a print job from the client computer 110 for printing. After selection of a printer as discussed above at the client computer 110, a print job is submitted (at 502) at the client computer 110. The print job involves a document of a given format. The given format can be an image format or a native (original) format.

The client computer 110 determines (at 504) whether format conversion of the document is to be performed. Format conversion has to be performed if the document is in the native format, whereas format conversion does not have to be performed if the document is in the image format. If document format conversion is to be performed, the client computer 110 invokes conversion software (at 506) to convert the document to the image format. As used here, the term “image format” refers to a format used to represent any type of document that is universally or widely recognizable on various platforms.

After conversion of the document format, or after determining that document format conversion is not to be performed, the client computer 110 uploads (at 508) the document to the print server 108, such as by using the REST API 400 of FIG. 4. Alternatively, instead of the client computer 110 uploading the document, the client computer 110 can instead send a notification to the print server 108 such that the print server 108 can download the document from the client computer 110. At the print server 108, the print job is queued (at 510) (where queuing the print job includes storing the converted document if conversion was performed). The print server 108 can then provide (at 512) a notification to the selected print service provider that a print job is pending or may send the job itself. In the event of notification, the print service provider (e.g., the server computer 104 of the print service provider) downloads (at 514) the print job to perform printing (or other print-related service).

Instructions of software described above (including the client print software 114 and server print software 124 of FIG. 1) are loaded for execution on a processor (such as CPUs 116 and 126 in FIG. 1). The processor includes microprocessors, microcontrollers, processor modules or subsystems (including one or more microprocessors or microcontrollers), or other control or computing devices. As used here, a “processor” can refer to a single component or to plural components (e.g., one CPU or multiple CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of performing a network print-related service, comprising:
requesting, by a client computer, information relating to locations of print-related services accessible over a public network;
receiving, by the client computer in response to the requesting, identifications of locations at which available print-related services are accessible over the public network; and
selecting, according to the identifications of locations, one of the locations for submitting a request for a print-related service over the public network.

2. The method of claim 1, wherein receiving the identifications of locations comprises receiving the identifications of locations of print service providers.

3. The method of claim 2, wherein receiving the identifications of print service providers comprises receiving the identifications of print service providers that provide one or more of a public print network, a private print network, and a social print network.

4. The method of claim 1, further comprising:
requesting description of printers available from the selected location; and
in response to requesting the description of printers available from the selected location, receiving description of one or more printers available from the selected location,
wherein selecting one of the locations comprises selecting one of the one or more printers available from the selected location.

5. The method of claim 1, further comprising:
displaying, by the client computer, a map of the locations of the available print-related services.

6. The method of claim 5, wherein displaying the map comprises displaying a map provided by a map service provider.

7. The method of claim 1, wherein requesting the information relating to print-related services comprises submitting criteria information to a portal, wherein the criteria information enables the portal to narrow down the print-related services that are to be identified to the client computer.

8. The method of claim 7, wherein the criteria information includes location information of the client computer.

9. The method of claim 1, wherein the requesting is performed using a Representational State Transfer (REST) application programming interface (API).

10. The method of claim 1, further comprising converting a format of a document associated with the requested print-related service to a target format that is recognizable by a print service provider to which the requested print-related service is submitted.

11. A computer comprising:
a network interface to a network;
a processor to:
send a request over the network for identification of print-related services available over the network;
receive information relating to the available print-related services;
generate a visual representation of geographical locations, wherein the visual representation is annotated with locations of the available print-related services; and
submit a request for a print-related service over the network.

12. The computer of claim 11, wherein receiving the information relating to the available print-related services comprises receiving the information relating to available printers.

13. The computer of claim 11, wherein the request for the print-related service identifies an entity associated with a selected one of the locations.

14. The computer of claim 11, wherein location information associated with the computer is provided with the request.

15. The computer of claim 14, wherein the request is submitted to a web portal, and wherein the location information is useable by the web portal to reduce a number of the print-related services identified by the web portal in response to the request.

16. The computer of claim 11, further comprising a Representational State Transfer (REST) application programming interface (API) through which the request is submitted.

17. An article comprising at least one computer-readable storage medium containing instructions that upon execution by a computer cause the computer to:
receive a request from a client for identification of available printers accessible over a network;
access information to identify the available printers; and
send a response to the client, wherein the response contains information identifying locations at which the available printers are accessible.

18. The article of claim 17, wherein the instructions upon execution cause the computer to further:
receive a request from the client for a print-related service that is responsive to the information identifying locations at which the available printers are accessible.

19. The article of claim 18, wherein the instructions upon execution cause the computer to further submit a print job to one of the printers in response to the request for the print-related service:

20. The article of claim 17, wherein receiving the request for identification of available printers comprises a request that identifies a location of the client.
